(19) United States
(12) Patent Application Publication
(10) Pub. No.: US 2017/0220284 A1
(43) Pub. Date: Aug. 3, 2017

(54) BLOCK-LEVEL INTERNAL FRAGMENTATION REDUCTION USING A HEURISTIC-BASED APPROACH TO ALLOCATE FINE-GRAINED BLOCKS

(71) Applicant: NetApp, Inc., Sunnyvale, CA (US)

(72) Inventors: Sharad Jain, Santa Clara, CA (US); Sudhindra Prasad Tirupati Nagaraj, Sunnyvale, CA (US); Vinay Hangud, Saratoga, CA (US)

(21) Appl. No.: 15/011,155

(22) Filed: Jan. 29, 2016

(51) Int. Cl. G06F 3/06; G06F 17/30

(52) U.S. Cl. CPC G06F 3/0631; G06F 3/0604; G06F 3/064; G06F 3/0671; G06F 17/30339

(57) ABSTRACT

Exemplary embodiments address the problem of disk fragmentation by using the heuristics of write operations to assign block sizes. As write requests are received, a storage system may register a size of the write request. Using the registered sizes, the storage system may identify one or more clusters of sizes at which write requests are particularly prevalent. The storage system may calculate a distribution or variance for block sizes centered on each cluster. The distribution or variance may be used to distribute the block sizes such that the block sizes change by a small amount in the vicinity of the cluster, and by a larger amount as the blocks move away from the center of the cluster. When it comes time to allocate new blocks, the clusters and distribution may be consulted to determine what sizes of blocks to allocate, and how many blocks of each size.

### TECHNICAL FIELD

The present application relates to data storage, and more particularly to techniques for allocating storage blocks in a data storage system.

### BRIEF DESCRIPTION OF THE DRAWINGS

FIG. 1A depicts an exemplary cluster hosting virtual machines.

FIG. 1B depicts an exemplary environment suitable for use with embodiments described herein.

FIG. 2 depicts an exemplary system in which write requests are processed.

FIG. 3 is a graph depicting an exemplary distribution of sizes of write operation requests.

FIG. 4 depicts exemplary blocks allocated based on the graph of FIG. 3.

FIG. 5 is a flowchart describing an exemplary method for registering a size of incoming write requests.

FIG. 6 is a flowchart describing an exemplary method for dynamically allocating block sizes.

FIG. 7 depicts exemplary computing logic suitable for carrying out the method depicted in FIG. 6.

FIG. 8 depicts an exemplary computing device suitable for use with exemplary embodiments.

FIG. 9 depicts an exemplary network environment suitable for use with exemplary embodiments.

### DETAILED DESCRIPTION

When writing data to a storage device, disk areas available to receive data are allocated as blocks. The blocks typically have a fixed size determined by the storage system (e.g., 1 MB). If the storage system attempts to store data that is smaller than the block size, some of the block remains unused. On the other hand, if the storage system attempts to store data that is larger than the block size, more than one block is used (although, if the data is not an exact multiple of the block size, some portion of a block may remain unused).

Thus, as the storage system writes data to allocated blocks, some empty spaces remain on the disk. Moreover, when the storage system is finished with certain storage space, it may be re-used (e.g., freed to be written over); the re-used locations may be in random locations on the disk. Accordingly, over time the available storage space becomes fragmented into multiple non-contiguous chunks. This fragmentation forces incoming write requests to be split between available storage in different portions of the disk, which decreases drive access efficiency. This problem is compounded if the incoming write operations are for objects of varying sizes.

It is also possible to allocate blocks having varied sizes. For example, some blocks may be allocated at 1 MB, some at 2 MB, some at 3 MB, etc. Although this helps to reduce the problem, fragmentation still exists to a large degree in this scenario.

Exemplary embodiments described herein address the problem of disk fragmentation by using the heuristics of write operations to assign block sizes. By using the write operation heuristics, block sizes can be selected to allow blocks to be used more efficiently as compared to a uniform distribution of block sizes (whether fixed or varied).

As write requests are received, the storage system may register a size of the write request, and may optionally assign the write request to a category. The categories may represent, for example, different types of data (e.g., music, pictures, text files, etc.), different originators of the write request (e.g., write requests from a first client, second client, etc.), or other categorizations.

Using the registered sizes, the storage system may identify one or more clusters of sizes at which write requests are particularly prevalent (overall, or for a given category). The storage system may calculate a distribution or variance for block sizes centered on each cluster. The distribution or variance may be used to distribute the block sizes such that the block sizes change by a small amount in the vicinity of the cluster, and by a larger amount as the blocks move away from the center of the cluster.

When it comes time to allocate new blocks, the clusters and distribution may be consulted to determine what sizes of blocks to allocate, and how many blocks of each size.

As an aid to understanding, a series of examples will first be presented before detailed descriptions of the underlying implementations are described. It is noted that these examples are intended to be illustrative only and that the invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, . . . , 122-a. The embodiments are not limited in this context.

Overview of a Data Storage System

Before describing the exemplary block allocation techniques in detail, an exemplary environment in which the techniques may be employed is first described.

In general, exemplary embodiments may be employed in any system in which data storage is allocated in blocks. For example, a personal computer may include a hard drive on which data is stored, and the available storage space on the hard drive may be allocated according to the block allocation technique described herein. Because it is expected that one of ordinary skill in the art will be familiar with such a system, a detailed overview is omitted for the sake of brevity.

In addition to application on a personal computing system, exemplary embodiments may be particularly well-suited to managing block allocation in a shared or clustered storage environment. Such systems tend to see a higher volume to write operations and block allocation requests, allowing for better and more accurate block size calculations.

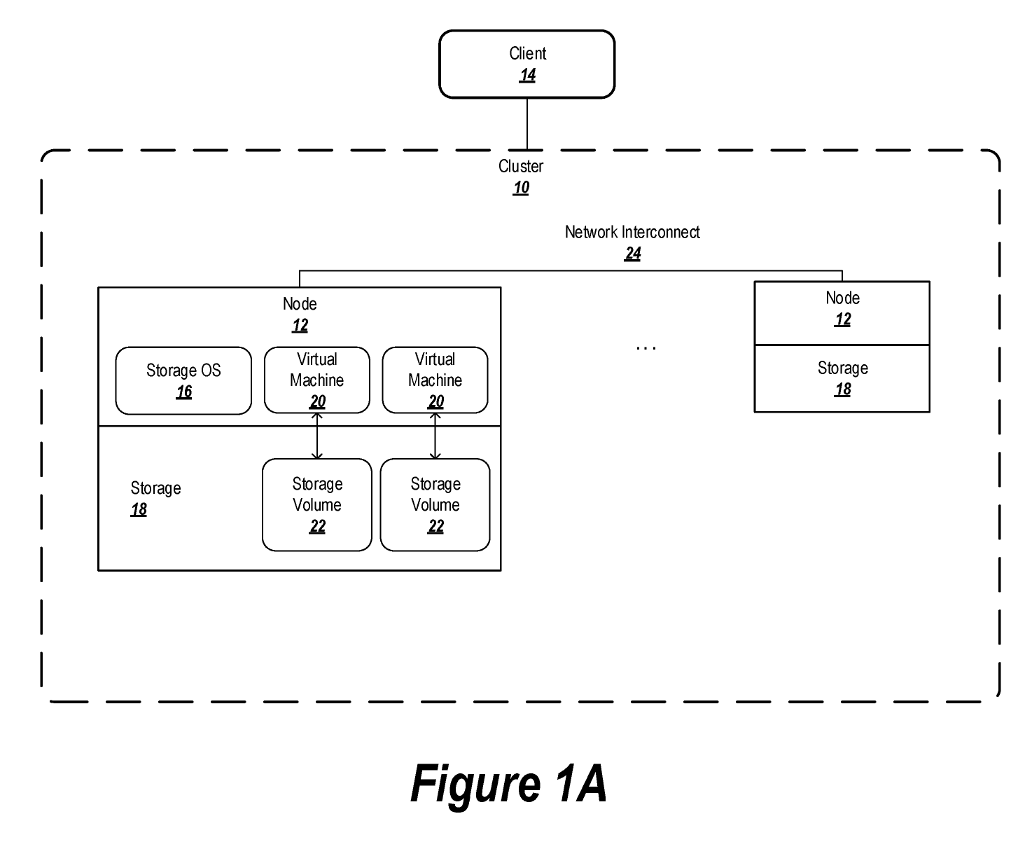

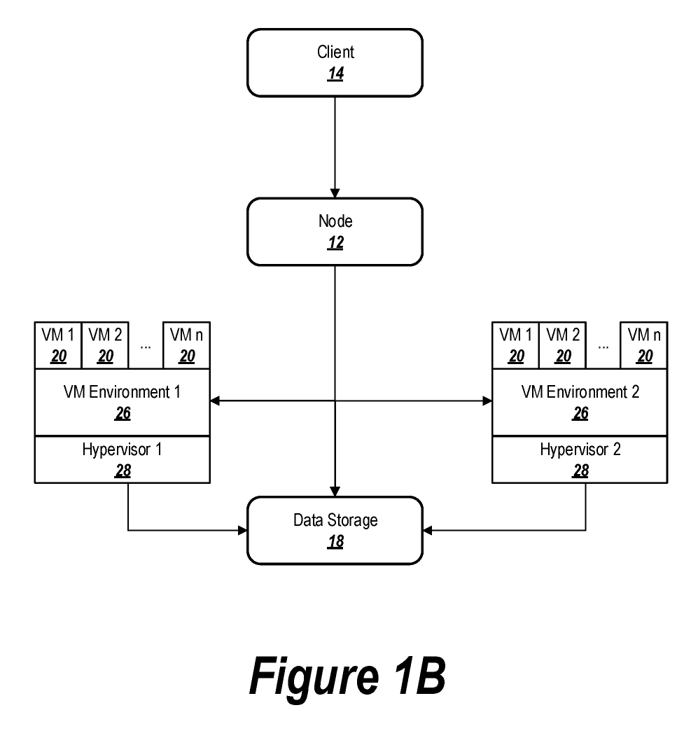

FIGS. 1A and 1B depict an example of a clustered storage environment in which the exemplary block allocation techniques may be employed.

FIG. 1A depicts an example of a cluster 10 suitable for use with exemplary embodiments. A cluster 10 represents a collection of one or more nodes 12 that perform services, such as data storage or processing, on behalf of one or more clients 14.

In some embodiments, the nodes 12 may be special-purpose controllers, such as fabric-attached storage (FAS) controllers, optimized to run a storage operating system 16 and manage one or more attached storage devices 18. The nodes 12 provide network ports that clients 14 may use to access the storage 18. The storage 18 may include one or more drive bays for hard disk drives (HDDs), flash storage, a combination of HDDs and flash storage, and other non-transitory computer-readable storage mediums.

The storage operating system 16 may be an operating system configured to receive requests to read and/or write data to one of the storage devices 18 of the cluster 10, to perform load balancing and assign the data to a particular storage device 18, and to perform read and/or write operations (among other capabilities). The storage operating system 16 serves as the basis for virtualized shared storage infrastructures, and may allow for nondisruptive operations, storage and operational efficiency, and scalability over the lifetime of the system. One example of a storage operating system 16 is the Clustered Data ONTAP® operating system of NetApp, Inc. of Sunnyvale, Calif.

The nodes 12 may be connected to each other using a network interconnect 24. One example of a network interconnect 24 is a dedicated, redundant 10-gigabit Ethernet interconnect. The interconnect 24 allows the nodes 12 to act as a single entity in the form of the cluster 10.

A cluster 10 provides hardware resources, but clients 14 may access the storage 18 in the cluster 10 through one or more storage virtual machines (SVMs) 20. SVMs 20 may exist natively inside the cluster 10. The SVMs 20 define the storage available to the clients 14. SVMs 20 define authentication, network access to the storage in the form of logical interfaces (LIFs), and the storage itself in the form of storage area network (SAN) logical unit numbers (LUNs) or network attached storage (NAS) volumes.

SVMs 20 store data for clients 14 in flexible storage volumes 22. Storage volumes 22 are logical containers that contain data used by applications, which can include NAS data or SAN LUNs. The different storage volumes 22 may represent distinct physical drives (e.g., different HDDs) and/or may represent portions of physical drives, such that more than one SVM 20 may share space on a single physical drive.

Clients 14 may be aware of SVMs 20, but they may be unaware of the underlying cluster 10. The cluster 10 provides the physical resources the SVMs 20 need in order to serve data. The clients 14 connect to an SVM 20, rather than to a physical storage array in the storage 18. For example, clients 14 require IP addresses, World Wide Port Names (WWPNs), NAS volumes, SMB (CIFS) shares, NFS exports, and LUNs. SVMs 20 define these client -facing entities, and use the hardware of the cluster 10 to deliver the storage services. An SVM 20 is what users connect to when they access data.

Connectivity to SVMs 20 is provided through logical interfaces (LIFs). A LIF has an IP address or World Wide Port Name used by a client or host to connect to an SVM 20. A LIF is hosted on a physical port. An SVM 20 can have LIFs on any cluster node 12. Clients 14 can access data regardless of the physical location of the data in the cluster 10. The cluster 10 will use its interconnect 24 to route traffic to the appropriate location regardless of where the request arrives. LIFs virtualize IP addresses or WWPNs, rather than permanently mapping IP addresses and WWPNs to NIC and HBA ports. Each SVM 20 may use its own dedicated set of LIFs.

Thus, like compute virtual machines, SVMs 20 decouple services from hardware. Unlike compute virtual machines, a single SVM 20 can use the network ports and storage of many nodes 12, enabling scale-out. One node's 12 physical network ports and physical storage 18 also can be shared by many SVMs 20, enabling multi-tenancy.

A single cluster 10 can contain multiple SVMs 20 targeted for various use cases, including server and desktop virtualization, large NAS content repositories, general-purpose file services, and enterprise applications. SVMs 20 can also be used to separate different organizational departments or tenants. The components of an SVM 20 are not permanently tied to any specific piece of hardware in the cluster 10. An SVM's volumes 22, LUNs, and logical interfaces can move to different physical locations inside the cluster 10 while maintaining the same logical location to clients 14. While physical storage and network access moves to a new location inside the cluster 10, clients 14 can continue accessing data in those volumes or LUNs, using those logical interfaces.

This capability allows a cluster 10 to continue serving data as physical nodes 12 are added or removed from the cluster 10. It also enables workload rebalancing and native, nondisruptive migration of storage services to different media types, such as flash, spinning media, or hybrid configurations. The separation of physical hardware from storage services allows storage services to continue as all the physical components of a cluster are incrementally replaced. Each SVM 20 can have its own authentication, its own storage, its own network segments, its own users, and its own administrators. A single SVM 20 can use storage 18 or network connectivity on any cluster node 12, enabling scale-out. New SVMs 20 can be provisioned on demand, without deploying additional hardware.

One capability that may be provided by a storage OS 16 is storage volume snapshotting. When a snapshot copy of a volume 22 is taken, a read-only copy of the data in the volume 22 at that point in time is created. That means that application administrators can restore LUNs using the snapshot copy, and end users can restore their own files.

Snapshot copies are high-performance copies. When writes are made to a flexible volume 22 that has an older snapshot copy, the new writes are made to free space on the underlying storage 18. This means that the old contents do not have to be moved to a new location. The old contents stay in place, which means the system continues to perform quickly, even if there are many Snapshot copies on the system. Volumes 22 can thus be mirrored, archived, or nondisruptively moved to other aggregates.

Therefore, snapshotting allows clients 14 to continue accessing data as that data is moved to other cluster nodes. A cluster 10 may to continue serving data as physical nodes 12 are added or removed from it. It also enables workload rebalancing and nondisruptive migration of storage services to different media types. No matter where a volume 22 goes, it keeps its identity. That means that its snapshot copies, its replication relationships, its deduplication, and other characteristics of the flexible volume remain the same.

The storage operating system 16 may utilize hypervisor-agnostic or hypervisor-independent formatting, destination paths, and configuration options for storing data objects in the storage devices 18. For example, Clustered Data ONTAP® uses the NetApp WAFL® (Write Anywhere File Layout) system, which delivers storage and operational efficiency technologies such as fast, storage-efficient copies; thin provisioning; volume, LUN, and file cloning; deduplication; and compression. WAFL® accelerates write operations using nonvolitile memory inside the storage controller, in conjuction with optimized file layout on the underlying storage media. Clustered Data ONTAP® offers integration with hypervisors such as VMware ESX® and Microsoft® Hyper-V®. Most of the same features are available regardless of the protocol in use.

Although the data objects stored in each VM's storage volume 22 may be exposed to the client 14 according to hypervisor-specific formatting and path settings, the underlying data may be represented according to the storage operating system's hypervisor-agnostic configuration.

Management of the cluster 10 is often performed through a management network. Cluster management traffic can be placed on a separate physical network to provide increased security. Together, the nodes 12 in the cluster 10, their client-facing network ports (which can reside in different network segments), and their attached storage 18 form a single resource pool.

FIG. 1B shows the configuration of the SVMs 20 in more detail. A client 14 may be provided with access to one or more VMs 20 through a node 12, which may be a server. Typically, a guest operating system (distinct from the storage OS 18) runs in a VM 20 on top of an execution environment platform 26, which abstracts a hardware platform from the perspective of the guest OS. The abstraction of the hardware platform, and the providing of the virtual machine 20, is performed by a hypervisor 28, also known as a virtual machine monitor, which runs as a piece of software on a host OS. The host OS typically runs on an actual hardware platform, though multiple tiers of abstraction may be possible. While the actions of the guest OS are performed using the actual hardware platform, access to this platform is mediated by the hypervisor 28.

For instance, virtual network interfaces may be presented to the guest OS that present the actual network interfaces of the base hardware platform through an intermediary software layer. The processes of the guest OS and its guest applications may execute their code directly on the processors of the base hardware platform, but under the management of the hypervisor 28.

Data used by the VMs 20 may be stored in the storage system 18. The storage system 18 may be on the same local hardware as the VMs 20, or may be remote from the VMs 20. The hypervisor 28 may manage the storage and retrieval of data from the data storage system 18 on behalf of the VMs 20. Different types of VMs 20 may be associated with different hypervisors 28. Each type of hypervisor 28 may store and retrieve data using a hypervisor-specific style or format.

Next, exemplary block allocation techniques for managing the allocation of blocks in the storage system 18 is described.

Block Allocation Techniques

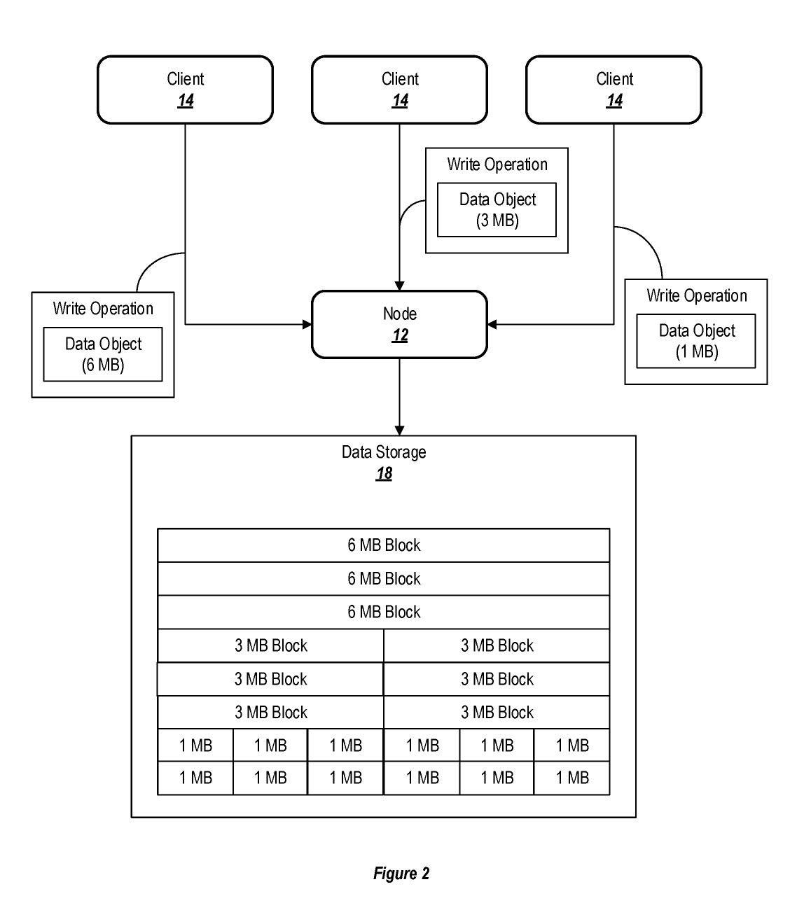

FIG. 2 provides a simplified overview of the concept behind the exemplary block allocation techniques described herein. In the system depicted in FIG. 2, three clients 14 each submit requests to a node 12, where the requests specify a write operation to be performed on a data object. In this example, the first node requests that a 6 MB data object be written to the data storage 18, the second node requests that a 3 MB data object be written to the data storage 18, and the third node requests that a 1 MB data object be written to the data storage 18.

After observing several such write requests, the node 12 may run out of blocks to which to write data, and may determine that more blocks need to be allocated. Based on node's observations of past write requests, the node 12 may determine that it is likely that requests of a similar size will occur in the future. Accordingly, as shown in FIG. 2, the node 12 allocates a number of blocks of size 6 MB, 3 MB, and 1 MB. As future write requests are received, the node 12 is more likely to find an appropriately-sized block in which to store the data object.

Thus, the node 12 dynamically tracks incoming write requests and uses this information to select block sizes when it comes time to allocate new blocks. By using the past history of write operations, blocks can be allocated in a manner that better fits the storage needs of the users involved.

Of course, not all write requests will fit exactly into a limited number of block sizes. However, the present inventors have discovered that, in practice, write requests tend to cluster around certain data values, often depending on the compressibility of the data. For example, file system data tends to compress very well, and thus when file system data is written to a storage system, a number of write requests tend to come in for relatively small data objects clustered in a limited range of sizes. On the other hand, media files do not tend to compress very well, and hence may be larger; nonetheless, files representing media items such as songs or short videos tend to be of about the same size, and thus a number of write requests may be received for relatively large data objects clustered in another limited range (although this range may be perhaps more spread out than the range for the file system data—in other words, the data object sizes in this cluster may be spread out over a larger range and may be less densely packed within that range).

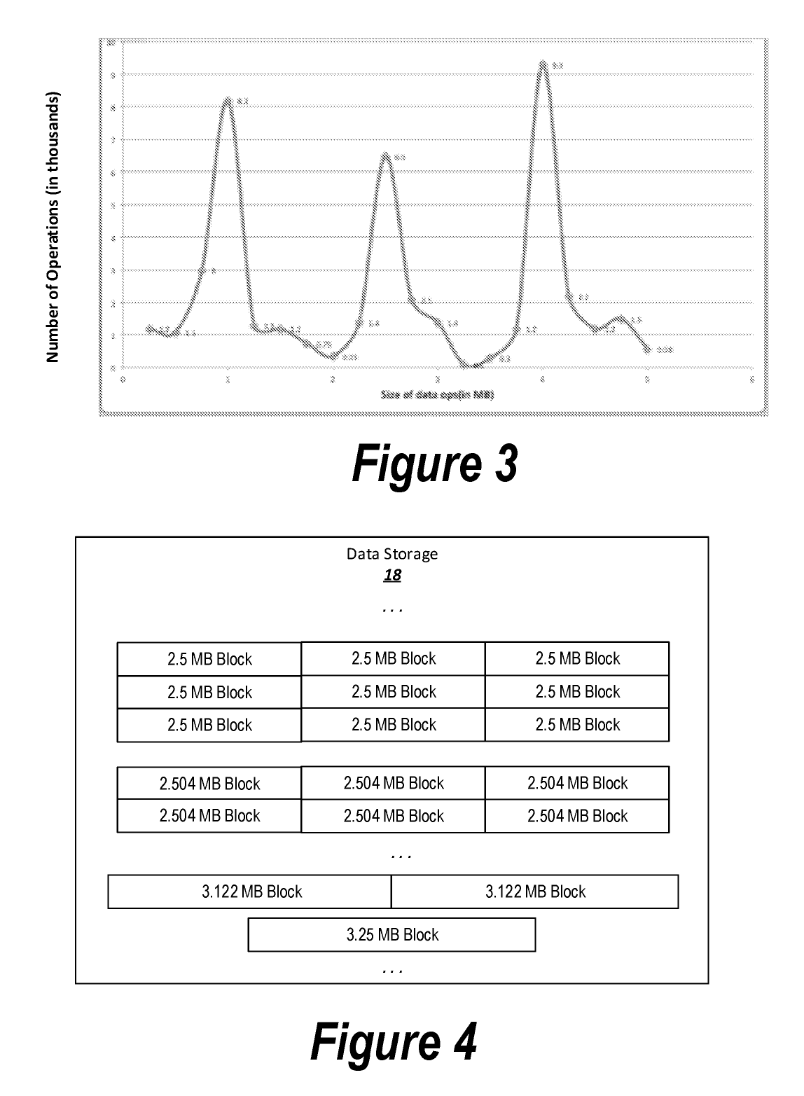

To better illustrate this phenomenon, FIG. 3 depicts a distribution of exemplary samples of the size of write requests received over a given period of time. In FIG. 3, the x-axis represents the size of data objects associated with requested write operations received by a node, while the y-axis represents the number of times that each of the sizes was observed in a write request.

As can be seen in the graph, the write requests include 3 high-density clusters—1 MB in size with 8200 objects, 2.5 MB in size with 6500 objects, and 4 MB in size with 9200 objects. Based on this data, a block allocation technique may allocate more blocks at these sizes, and may carve out more fine-grained data blocks around these sizes.

For example, around a high-density region of 1 MB, blocks varying in size by a relatively small amount (e.g., +/−4 KB in size) may be carved out. The range of block allocation increases gradually as the block sizes move away from the high-density region. Variation increases as the block size moves away from the high-density region. For instance, around a low density region (e.g., 3.25 MB), the variation in block sizes may be much higher (e.g., +/−128 KB). Although this means that there will be relatively few blocks allocated in the low-density region and therefore internal fragmentation may exist for write operations performed at this size, it is known from previous experience (based on the graph in FIG. 3) that the number of write requests of this size is relatively low. Thus, fragmentation will be less of a problem at these sizes. In contrast, having a +/−4 KB size variation in the high density areas (e.g., the 1 MB region), where allocation is high, can greatly reduce internal fragmentation for these often-requested sizes.

FIG. 4 shows a segment of a data storage 18 in which blocks have been allocated based on the history shown in FIG. 3. At a high-density area (at 2.5 MB, where we observed about 6,500 requests), many blocks have been allocated. In a low-density area (at 3.25 MB, where we observed about 300 requests), relatively few blocks have been allocated. In between, blocks have been allocated based on a distribution that places relatively more blocks around the high-density area and relatively fewer blocks around the low density area. This is achieved by gradually increasing the difference between block sizes from the high density area to the low density area: whereas the difference in sizes in the vicinity of the high density area is only +/−4 KB, the difference in sizes in the vicinity of the low density area is larger, at +/−128 KB, with a gradual increase in size differences from the high density area to the low density area.

This scheme will lead to a natural fine-grained block size carving around high-density data cluster sizes, which will lead to an overall reduction in internal block fragmentation. This approach is better than a uniform distribution of variable sizes across the entire block spectrum.

This approach solves a number of issues. Since the granularity is very fine in the dense region, this reduces the internal block fragmentation (since we expect that most of the incoming objects will fall within this region). This approach can accommodate different data patterns to provide a generic solution to allocating variable fixed size blocks. Moreover, the approach reduces the unnecessary allocation of blocks that might not be needed.

These benefits are achieved without the need to roll out new hardware, meaning that exemplary embodiments can be used to improve disk I/O performance even on an aged system.

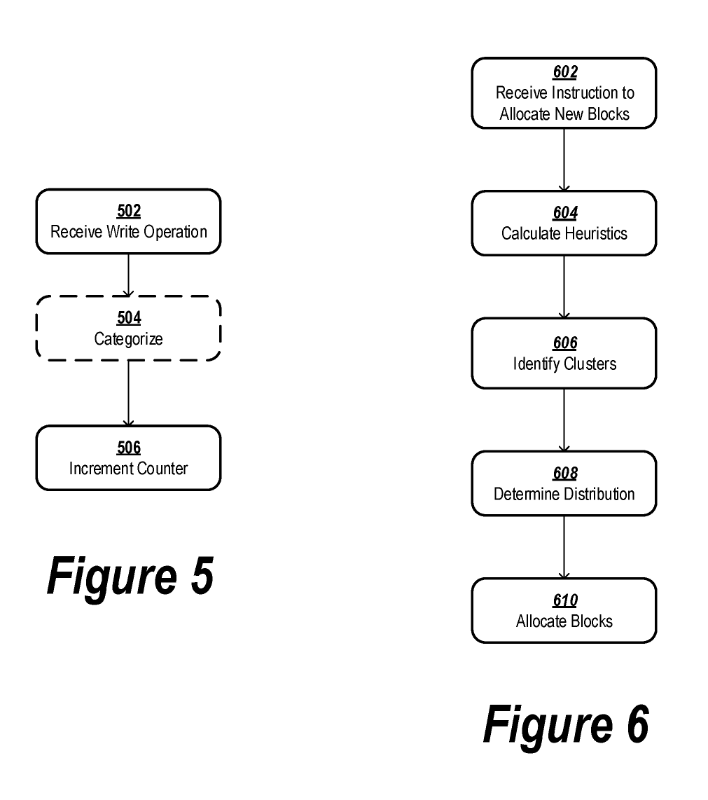

The information contained in the graph depicted in FIG. 3 can be constructed by measuring the size of incoming write requests, while the block allocation pattern depicted in FIG. 4 can be determined by analyzing this information using a block allocation algorithm. These techniques are described in more detail in connection with FIGS. 5 and 6, below.

### Exemplary Methods, Mediums, and Systems

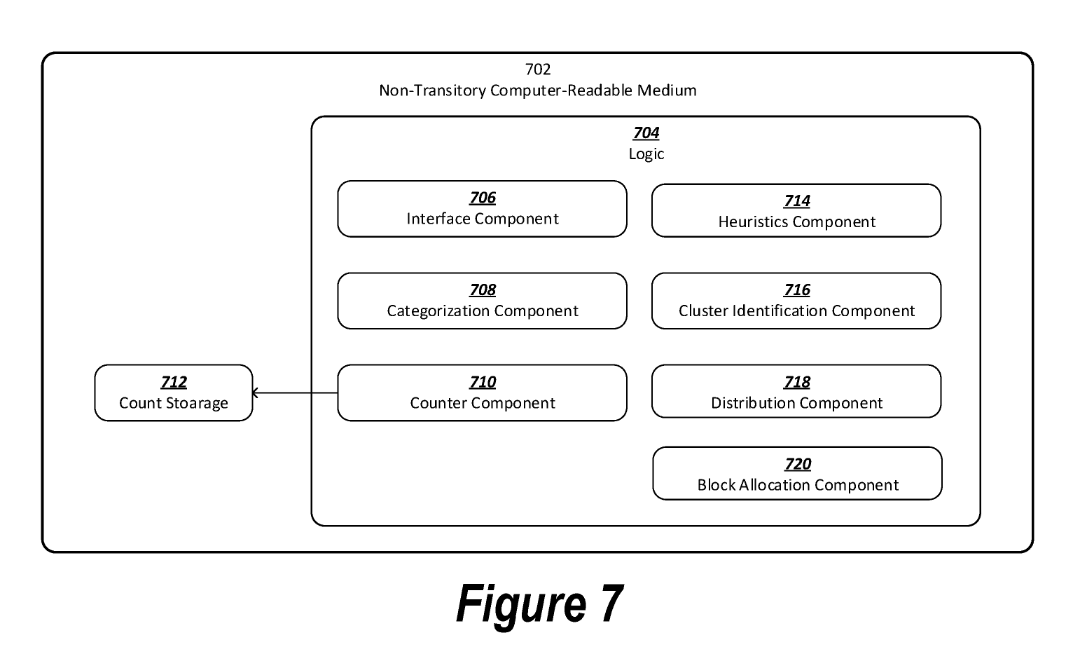

FIG. 5 depicts an exemplary method for counting the number of received write operations corresponding to different data sizes. FIG. 6 depicts an exemplary block allocation method using the counts calculated in FIG. 5. The methods of FIGS. 5 and 6 may be implemented as computer-executable instructions stored on a non-transitory computer readable medium, as illustrated in FIG. 7.

With reference to FIG. 5, at step 502 a request to perform a write operation may be received. The request may specify a data object that is to be written to a data storage device. The data object may have a size. Step 502 may be performed by an interface component 706, as depicted in FIG. 7.

At step 504, the storage system may optionally categorize the request based on any of a number of factors. For example, the request may be categorized based on a type of the data object, by an originator of the request, etc. This categorization may be used to provide a more fine-grained analysis when it comes time to allocate future blocks. For example, the size characteristics and distributions of write requests associated with music files may be different than those associated with text files. If the system determines that new blocks need to be allocated and are likely to be filled by write requests for music files, then the system may perform the block allocation techniques described in FIG. 6 using the data collected for music files, while filtering out the data collected for text files. Alternatively or in addition, different categories may be combined in differing amounts: if future requests are expected to include mostly music files but also a few text files, then the respective categories may be weighted in order to allow some allocation for text files while reserving the bulk of the allocation for music files. Step 504 may be performed by a categorization component 708, as depicted in FIG. 7.

At step 506, the system may increment a counter associated with a size generally corresponding to the size of the data object associated with the write operation received in step 502. In order to decrease the number of counters that need to be maintained and simplify the process, the size of the data object may be rounded to a convenient number depending on the size of the data object (e.g., to the nearest 0.1 MB for an object of size 1 MB-10 MB, to the nearest 10 MB for an object of size 100 MB-1 GB, to the nearest 10 KB for an object of size 10 KB-1 MB, etc.). The respective counters may be stored in a list, a table, a database, etc. Step 506 may be carried out by a counter component 710, as depicted in FIG. 7.

The counts determined at step 506 may be used as part of a block allocation technique, as shown in FIG. 6. At step 602, the system may receive instructions to allocate a new set of blocks for storage. The instruction may be received as a result of a determination that there are insufficient blocks available to the system (e.g., if the number of blocks available, or the total size of the allocated blocks, falls below a predetermined threshold). Alternatively or in addition, the instruction may be received when new data storage is brought online, in order to perform an initial block allocation. In this case, the system may use size counts previously calculated for other storage devices situated in a similar manner (e.g., if new storage is added to a cluster, then a history of previous write requests processed by the cluster may be used in the block allocation algorithm). Step 602 may be performed by an interface component 706, as depicted in FIG. 7.

At step 604, the system may calculate heuristics associated with the previously-received write requests. The heuristics may include, for example, a frequency at which different data object sizes have been received. The counts may be analyzed to determine a shape of a resulting distribution, such as a standard deviation of one or more curves in the distribution. Step 604 may be carried out by a cluster identification component 716, as depicted in FIG. 7.

At step 606, one or more clusters in the distribution may be determined. For example, a predetermined threshold may be consulted. If the frequency of a particular data object size exceeds the predetermined threshold, then the respective data object size may be identified as being part of a cluster. If multiple contiguous or neighboring data object sizes each exceed the threshold, then these contiguous or neighboring data object sizes may be identified as belonging to the same cluster (e.g., if the threshold is set at 2,000 operations in FIG. 3, then from about 0.8 MB to about 1.2 MB would be identified as belonging to a cluster centered at about 1 MB. The data may include multiple clusters.

Alternatively or in addition, clusters may be identified based on where areas of relatively high density (e.g., exceeding a predetermined threshold) are interrupted by one or more troughs in the data (e.g., areas falling below a predetermined threshold). For example, in FIG. 3, a trough from about 1.2 MB to about 2.2 MB separates the 1 MB cluster from the 2.5 MB cluster. Step 606 may be carried out by a distribution component 718, as depicted in FIG. 7.

At step 608, the system may determine a distribution of blocks to be allocated. The distribution may be calculated based on the clusters identified in step 606 and/or the heuristics calculated in step 604. As noted above, the distribution may cause relatively more blocks to be allocated for block sizes having a high density in the distribution, and relatively fewer blocks to be allocated for block sizes having a lower density in the distribution. This may be achieved by increasing the distance between the sizes of adjacent blocks as the blocks approach a low density region, and decreasing the distance between the sizes of adjacent blocks as the blocks approach a high density region. Moreover, relatively more blocks may be allocated for each size in the high density region (increasing in number as the block size approaches the data object size of highest frequency), and relatively fewer blocks may be allocated for each size in the low density region (decreasing in number as the block size approaches the data object size of lowest frequency).

The number and distribution of block sizes may vary depending on the size and shape of the curves determined in step 604. For example, a relatively steep curve (e.g., represented by a low standard deviation) may result in the distance between adjacent block sizes increasing more quickly, whereas a relatively shallow curve (e.g., represented by a high standard deviation) may result in the distance between adjacent block sizes increasing more slowly.

Step 608 may be carried out by a distribution component 718, as depicted in FIG. 7.

At step 610, the system may allocate new blocks according to the distribution calculated in step 608. For example, one or more allocation commands specifying the calculated block sizes may be issued to or by the operating system (such as the storage operating system). Step 610 may be carried out by a block allocation component 720, as depicted in FIG. 7.

One of ordinary skill in the art will recognize that the block allocation and distribution may be determined in other ways. For example, the distribution (e.g., as depicted in FIG. 3) may be modeled according to one or more equations, and the equations may be used to calculate a corresponding number and size of blocks to allocate.

The method of FIG. 5 may run continuously in the background, as new write requests are received. Meanwhile, the method of FIG. 6 may be run specifically in response to a request to allocate new blocks. Thus, the information determined in FIG. 5 is calculated dynamically and continuously, whereas the method of FIG. 6 uses the dynamically-calculated data to perform block allocation on an as-needed basis.

With reference to FIG. 7, an exemplary computing system may store, on a non-transitory computer-readable medium 702, logic 704 that, when executed, cause the computing system to perform the steps described above in connection with FIGS. 5 and 6. The logic 704 may include instructions stored on the medium 702, and may be implemented at least partially in hardware.

The logic 704 may include: an interface component 706 configured to execute instructions corresponding to steps 502 of FIG. 5 and 602 of FIG. 6 (the interface component 706 may include at least some hardware, such as a processor and/or network interface for receiving requests over a network); a categorization component 708 configured to execute instructions corresponding to step 504 of FIG. 5; a counter component 710 configured to execute instructions corresponding to step 506 of FIG. 5 in conjunction with a count storage 712 such as a table, list, database, etc.; a heuristics component 714 configured to execute instructions corresponding to step 604 of FIG. 6; a cluster identification component 716 configured to execute instructions corresponding to step 606 of FIG. 6; a distribution component 718 configured to execute instructions corresponding to step 608 of FIG. 6; and a block allocation component 720 configured to execute instructions corresponding to step 610 of FIG. 6. Some or all of the modules may be combined, such that a single module performs the several of the functions described above. Similarly, the functionality of one of the described modules may be split into multiple modules, or redistributed to other modules. The modules and related components may be stored on a single medium 702, or may be split between multiple mediums 702.

### Computer-Related Embodiments

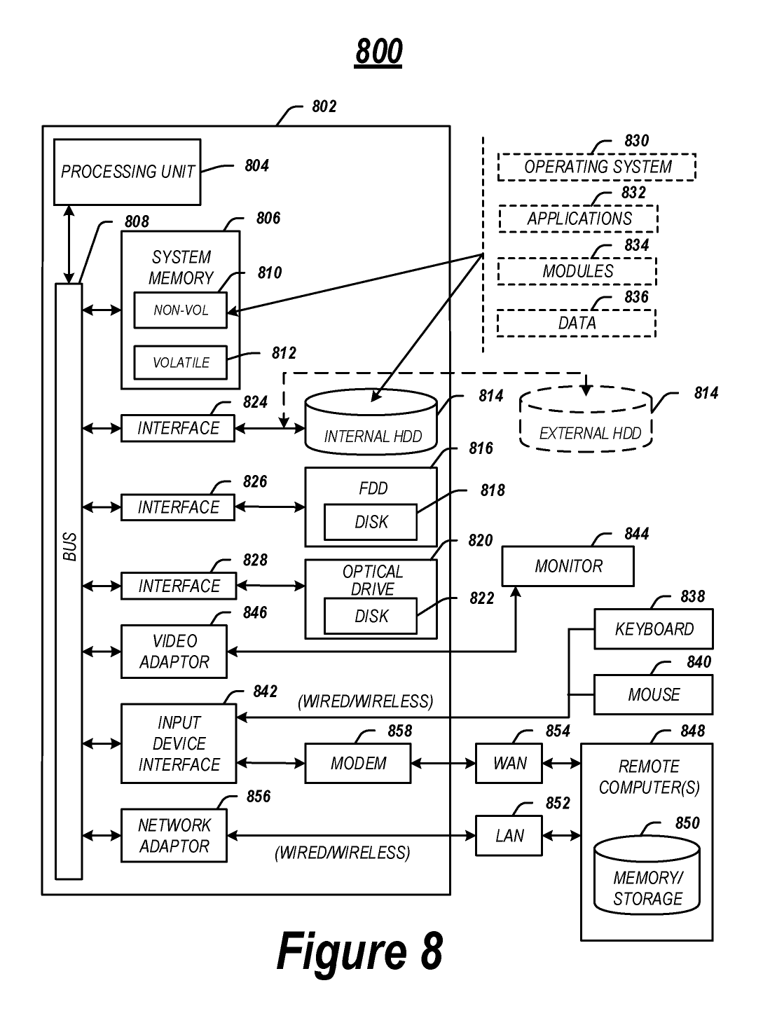

The above-described method may be embodied as instructions on a computer readable medium or as part of a computing architecture. FIG. 8 illustrates an embodiment of an exemplary computing architecture 800 suitable for implementing various embodiments as previously described. In one embodiment, the computing architecture 800 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 694 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 30.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 504 through an input device interface 842 that is coupled to the system bus 808, but can be connected by other interfaces such as a parallel port, IEEE 694 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

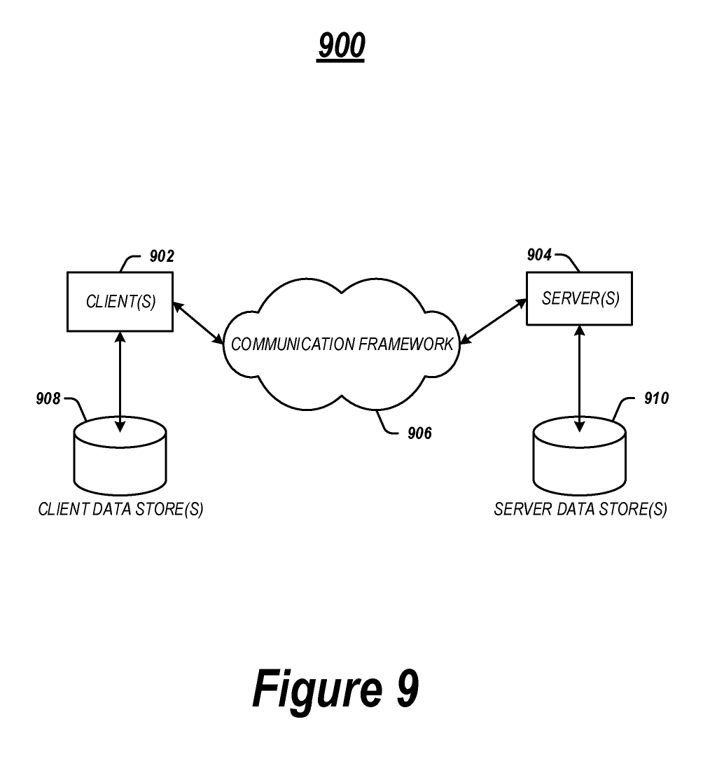

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 may implement the client device 14 shown in FIG. 1A. The servers 604 may implement the server device 104 shown in FIG. 1A. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

### General Notes on Terminology

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system comprising:
an interface component, implemented at least partially in hardware, configured to receive a plurality of write operations, each write operation associated with a data object having a size;
a cluster identification component configured to identify one more clusters of data objects having similar sizes; and
a block allocation component configured to allocate blocks in a storage device, the blocks having a size determined at least in part based on the identified clusters.

2. The system of claim 1, further comprising a counter component, the counter component configured to increment a count in a count database, the count corresponding to a particular data object size for one of the respective received write operations.

3. The system of claim 1, further comprising a heuristics component configured to evaluate frequencies at which the write operations are received for a plurality of data object sizes and to provide the frequencies to the cluster identification component for use in identifying the clusters.

4. The system of claim 1, further comprising a distribution component configured to calculate a distribution of the data object sizes.

5. The system of claim 4, wherein the distribution component is further configured to cause relatively fewer blocks to be allocated by the block allocation component at a size corresponding to one or more areas of a low frequency of data object sizes in the distribution.

6. The system of claim 4, wherein the distribution component is further configured to cause relatively more blocks to be allocated by the block allocation component at a size corresponding to one or more areas of a high frequency of data object sizes in the distribution.

7. The system of claim 1, further comprising a categorization component configured to classify incoming write operations into one of a plurality of categories, wherein the block allocation component allocates new blocks based at least in part on a determination that future write requests are likely to occur in one of the plurality of categories.

8. A non-transitory computer-readable storage medium storing instructions that are configured to cause one or more processors to:
receive a request to store a data object in a storage device;
increment a counter associated with a size corresponding to a size of the data object; and
allocate a plurality of blocks in a storage device, the blocks having a plurality of block sizes determined at least in part based on the counter.

9. The medium of claim 8, further configured to cause the one or more processors to identify one or more clusters of data object sizes, the one or more clusters used to allocate the plurality of blocks.

10. The medium of claim 8, further configured to receive a plurality of requests, and to cause the one or more processors to evaluate frequencies at which the requests are received for a plurality of data object sizes.

11. The medium of claim 8, further configured to cause the one or more processors to calculate a distribution of the data object sizes.

12. The medium of claim 11, further configured to cause the one or more processors to cause relatively fewer blocks to be allocated by the block allocation component at a size corresponding to one or more areas of a low frequency of data object sizes in the distribution.

13. The medium of claim 11, further configured to cause the one or more processors to cause relatively more blocks to be allocated by the block allocation component at a size corresponding to one or more areas of a high frequency of data object sizes in the distribution.

14. The medium of claim 8, further configured to cause the one or more processors to classify incoming requests into one of a plurality of categories, wherein the plurality of blocks are allocated based at least in part on a determination that future write requests are likely to occur in one of the plurality of categories.

15. A method comprising:
receiving, at an interface component implemented at least partially in hardware, a request to store a data object in a storage device;
incrementing a counter associated with a size corresponding to a size of the data object; and
allocating a plurality of blocks in a storage device, the blocks having a plurality of block sizes determined at least in part based on the counter.

16. The method of claim 15, further comprising identifying one or more clusters of data object sizes, the one or more clusters used to allocate the plurality of blocks.

17. The method of claim 15, further comprising receiving a plurality of requests, and evaluating frequencies at which the requests are received for a plurality of data object sizes.

18. The method of claim 15, further comprising calculating a distribution of the data object sizes.

19. The method of claim 18, further comprising allocating relatively fewer blocks at a size corresponding to one or more areas of a low frequency of data object sizes in the distribution, or allocating relatively more blocks at a size corresponding to one or more areas of a high frequency of data object sizes in the distribution.

20. The method of claim 15, further comprising classifying incoming requests into one of a plurality of categories, wherein the plurality of blocks are allocated based at least in part on a determination that future write requests are likely to occur in one of the plurality of categories.
